(19) United States
(12) Patent Application Publication
(10) Pub. No.: US 2004/0236129 A1
(43) Pub. Date: Nov. 25, 2004

(54) Optically active catalysts

(76) Inventors: Bettin Kirschbaum, Frankfurt (DE); Rainer Fell, Gersthofen (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/482,530

(22) PCT Filed: Jun. 18, 2002
(86) PCT No.: PCT/EP02/06685

(30) Foreign Application Priority Data
Jun. 30, 2001 (DE) 101318111

(51) Int. Cl. C07F 11/00

(52) U.S. Cl. 556/32

(57) ABSTRACT

An optically active catalyst containing a salen ligand of formula (II) and vanadium at oxidation stage (IV), wherein the groups R, R′ and R″ of the salen ligand independently of one another represent hydrogen, branched or unbranched C₁-C₁₀ alkyl groups or an O(C₁-C₄-alkyl) group or F, Cl, Br or I, an optionally substituted aryl group, or —(CH₂)ₘ— whereby m represents a whole number ranging between 1 and 8 and the catalyst contains between 1.4 and 10 equivalents of a salen ligand for an equivalent of vanadium (IV).

The invention relates to a class of optically active vanadyl catalysts which are suitable for preparing optically active cyanohydrins.

Optically active cyanohydrins and their subsequent products, for example optically active α-hydroxy carboxylic acids, serve as building blocks for obtaining biologically active substances which find use, for example, in the pharmaceutical or agrochemical industry. Cyanohydrins are obtainable by various chemical reactions, as described in Top. Curr. Chem. 1999, 200, 193-226.

One means of synthesizing optically active cyanohydrins is to convert aldehydes in the presence of molecules having “CN” groups (HCN, MCN where M is alkali metal, trimethylsilyl cyanide—also referred to as TMSCN, cyanohydrins, e.g. acetone cyanohydrin) and an optically active catalyst to (S)- or (R)-cyanohydrins, (Lit. review, Compr. Asymmetric Catal. I-III, 1999 (2), Ch. 28).

A series of catalysts allows the enantioselective addition of the CN group to aldehydes, but primarily using trimethylsilyl cyanide as the CN source (Lit. I. P. Holmes, H. B. Kagan, Tetrahedron Lett. 2000, 41, 7457-7460. Y. Hamashima et al., Tetrahedron 2001, 57, 805-814. E. Leclerc et al., Tetrahedron: Asymmetry, 2000, 11, 3471-3474.).

For instance, when optically active transition metal catalysts, for example titanium-salen complexes of the formula (Ia), are used, an enantioselective addition of trimethylsilyl cyanide to aldehydes is known (Y. Belokon, J. Chem. Soc., Perkin Trans. 1 1997, 1293-1295. Y. N. Belokon et al. J. Am. Chem. Soc. 1999,121,3968-3973.).

Y. N. Belokon et al. (J. Am. Chem. Soc. 1999, 121, 3970) reported that there is no reaction with titanium-salen complexes when free HCN is used under the same conditions (at −80° C.). Y. N. Belokon et al. additionally report in Eur. J. Org. Chem. 2000, 2655-2661 that titanium-salen complexes, when free HCN is used, result even at room temperature in only a very slow reaction in comparison to the use of TMSCN. Good conversions and enantioselectivities consequently typically require low temperatures (−80° C.) and TMSCN as the cyanide source.

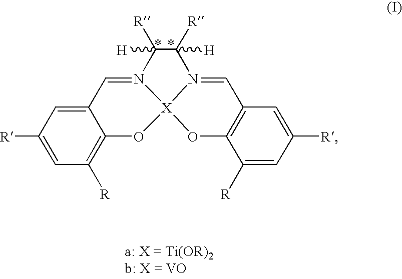

Although vanadyl-salen complexes of the formula (Ib) catalyze the reaction of aldehydes with trimethylsilyl cyanide in principle with higher enantioselectivity than the corresponding titanium-salen catalysts (Y. N. Belokon, M. North, T. Parsons, Org. Lett. 2000, 2, 1617-1619), only the use of TMSCN as the cyanide source is known here. The comparable reaction with the catalyst described in this literature and HCN as the cyanide source, carried out at room temperature, proceeds unsatisfactorily with regard to conversion and enantioselectivity, see also Comparative Example 2a.

A CN source such as trimethylsilyl cyanide is little suited to industrial use, since it is expensive and additionally causes large amounts of silicon wastes. The realization of low temperatures such as −80° C. in industrial application is likewise expensive and not very practical.

It is therefore an object of the present invention to provide a catalyst system which overcomes the above-outlined difficulties and limitations with regard to the CN source to be used and reaction temperature, and which can additionally be obtained in a simple manner.

The present invention achieves this object and relates to a class of optically active vanadyl catalysts containing from 1.4 to 10, preferably from 1.4 to 5, in particular 1.4 to 3, equivalents of a salen ligand of the general formula (II), based on one equivalent of vanadium in the oxidation state (IV).

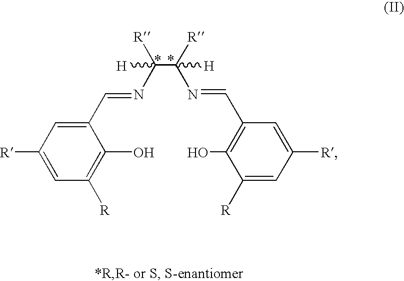

The R, R′ and R″ radicals of the salen ligand of the general formula (II) are each independently hydrogen, branched or unbranched C₁-C₁₀ alkyl radicals, in particular a methyl or tert-butyl radical, or an O(C₁-C₄-alkyl) group, in particular a methoxy group, or halogens F, Cl, Br or I, in particular Cl, an optionally substituted aryl group, in particular a phenyl group, or —(CH₂)ₘ—, where m is an integer between 1 and 8.

To prepare the catalysts according to the invention, vanadium is reacted in the oxidation state (IV), for example in the form of vanadyl(IV) salts, in particular vanadyl(IV) sulfate, free of water or with water of hydration, with from 1.4 to 10 equivalents, preferably with from 1.4 to 5 equivalents, in particular with 1.4 to 3 equivalents, of the appropriate salen ligand. The catalysts consisting of salen ligands of the formula (II) and vanadium in the oxidation state (IV) are preferably synthesized in C₁-C₆ aliphatic or C₆-C₁₀ aromatic alcohols, in particular in methanol, ethanol, 1-propanol or 2-propanol, or benzyl alcohol, in heterogeneous reaction environments, or in a chlorohydrocarbon/alcohol mixture, in particular a mixture of dichloromethane, chloroform, dichloroethane, trichloroethane, chlorobenzene, dichlorobenzene, trichlorobenzene or chlorotoluene/alcohol mixture, in a heterogeneous reaction environment.

The reaction takes place at a temperature of from 0 to 120° C., preferably at from 10 to 110° C., in particular at from 20 to 90° C.

The salen ligand is used in a concentration of from 0.005 to 5.0 mol/l, preferably in a concentration of from 0.01 to 2.5 mol/l, in particular in a concentration of from 0.05 to 1.0 mol/l, based on the solvent.

The reaction time for preparing the catalysts is from 1 to 24 h, preferably from 2 to 12 h, in particular from 3 to 5 h.

The catalysts according to the invention can be used in particular for preparing optically active cyanohydrins by reacting aldehydes with a CN source in an organic solvent at a temperature in the range from 0 to 60° C.

In a preferred embodiment, cyanohydrins of the formula (III)

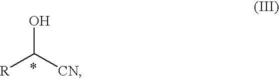

where the optically active center * has the absolute configuration (R) or (S), R is an optionally branched alkyl, alkenyl or alkynyl radical of chain length C₁ to C₂₀ or is a radical of the formula (IIIa)

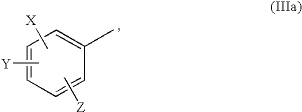

where X, Y and Z are each independently the same or different and are H, F, Cl, Br, I, OH, NH₂, O(C₁-C₄-alkyl), OCOCH₃, NHCOCH₃, NO₂ or C₁-C₄-alkyl,

are obtained by converting an aldehyde of the formula (IV)

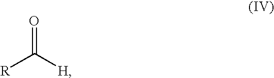

where R is as defined above.

Such a process for preparing optically active cyanohydrins is described in the German application P . . . (internal number R 4474) which has the same priority date as the present application and is explicitly incorporated herein by way of reference.

The vanadyl-salen catalysts are used by mixing the particular catalyst with the aldehyde and HCN in a suitable solvent. From 0.00005 to 0.05 equivalent of catalyst, preferably from 0.0001 to 0.01 equivalent of catalyst, are used, based on the aldehyde.

The reaction is carried out in the presence of the catalysts according to the invention, as already mentioned, at from 0 to 60° C., in particular from 10 to 50° C., preferably at from 20 to 40° C. In many cases, it has proven useful to allow the reaction to proceed at room temperature.

When the catalysts according to the invention are used, the CN source used may be pure hydrocyanic acid, acid-stabilized hydrocyanic acid or a cyanohydrin, in particular acetone cyanohydrin.

The cyanohydrin of the formula (III) present in the reaction mixture may optionally be converted by hydrolysis directly to the corresponding α-hydroxy carboxylic acid.

The advantage of using the catalysts according to the invention is that it is possible to not only convert the aldehydes in comparatively less concentrated amounts than hitherto customary, for example 0.1 mol of aldehyde/liter, but also to carry out the reaction with considerably higher aldehyde concentrations, for example from 2.0 mol of aldehyde/liter up to 10 mol of aldehyde/liter, preferably from 2 to 4 mol of aldehyde/liter. Accordingly, the space-time yield for stereoselective cyanohydrin reactions is unusually high.

The reaction with HCN in the presence of the catalysts according to the invention is carried out in an organic solvent. Suitable for this purpose are in principle all organic solvents or solvent mixtures which behave inertly under the conditions of the reaction.

Particularly suitable as solvents are C₆-C₁₀ aromatic and C₁-C₁₀ aliphatic, optionally halogenated hydrocarbons or solvent mixtures thereof, and aliphatic ethers having from 1 to 5 carbon atoms per alkyl radical, or cyclic ethers having from 4 to 5 carbon atoms in the ring.

Especially suitable are aromatic, optionally substituted C₆-C₁₀, preferably C₆-C₉, hydrocarbons, for example toluene, ortho-, meta- and/or para-xylene, chlorinated aliphatic or aromatic hydrocarbons such as methylene chloride, dichloroethane, trichloroethane, chloroform, chlorobenzene, dichlorobenzene and trichlorobenzene, or ethers, for example diethyl ether, di-n-propyl ether, diisopropyl ether, di-n-butyl ether and methyl tert-butyl ether.

On completion of the reaction, if desired, the optically active cyanohydrin can be isolated from the reaction mixture and optionally also purified. Using toluene as the solvent, the optically active cyanohydrin can be crystallized out, for example, under cold conditions, preferably at temperatures in the range from −20° C. to 10° C.

However, the optically active cyanohydrin, optionally in the form of the reaction mixture, can also be converted, for example by acid hydrolysis, to the corresponding optically active α-hydroxy carboxylic acid. For the acidic hydrolysis, it is customary to use strong mineral acids, such as conc. HCl or aqueous sulfuric acid. In the course of the hydrolysis, it is necessary to ensure good mixing of the aqueous phase in which the acid is present and the organic phase in which the optically active cyanohydrin is present. By adding an ether (e.g. diisopropyl ether) or a phase transfer catalyst (e.g. a polyethylene glycol), the rate of the hydrolysis reaction can be increased.

The catalysts according to the invention surprisingly enable aldehydes to be converted with high conversions and good ee values, using free hydrocyanic acid as the cyanide source, at room temperature, to the optically active cyanohydrins, both of the (S) and of the (R) series. In particular, it is possible to convert substrates which are particularly difficult, for example, for enzymatic processes, such as benzaldehydes substituted in the 2-position, e.g. 2-chlorobenzaldehyde, as desired to the corresponding optically active (S)- or (R)-cyanohydrins with good success by means of the process according to the invention.

### EXAMPLES

The examples which follow describe the invention in detail, without restricting it.

The ee values of the cyanohydrins obtained were determined by gas chromatography using a β-cyclodextrin column after derivatization with acetic anhydride/pyridine.

The VO-salen complex used in the examples which follow is a complex prepared from salen ligands of the formula (III) and vanadium in the oxidation state (IV), for example vanadyl(IV) sulfate.

Preparation of the VO-salen complex with the salen ligand IIa

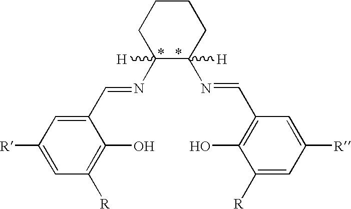

(IIa), R,R-enantiomer, R=R′=tert-butyl

### Example 1

Synthesis of VO-salen complex with the salen ligand (IIa):

5.46 g (0.01 mol) of (R,R)-2,2′-[1,2-cyclohexanediyl)bis(nitrilomethylidyne)]-bis[4,6-di-tert-butyl)phenol] are initially charged in 50 ml of ethanol and admixed with 1.14 g (0.0045 mol) of vanadyl sulfate pentahydrate. After three hours under reflux and complete conversion (TLC monitoring), the solvent is distilled off, the residue taken up in 200 ml of dichloromethane and the solution washed with 100 ml of water. After phase separation, drying of the solution with sodium sulfate and distilling off the solvent, 5.4 g of bright green, amorphous powder (yield: 96% of theory, based on a vanadium:salen ligand ratio of 1:2) are obtained.

Characterization:

| | |
|---|---|
| Color | bright green |
| Melting point | 208° C., with decomposition |

[α]D²⁰ = −300 (c = 0.01; CHCl₃)
paramagnetic

| | |
|---|---|
| IR (KBr) | ν = 2950 (s), 2870 (m), 2350 (w), 2320 (w), 1610 (vs), |
| | 1550 (m), 1270 (s) [cm⁻¹]. |

### Comparative Example 1a

Synthesis of VO-salen complex with the salen ligand (IIa):

5.56 g (0.01 mol) of (R,R)-2,2′-[1,2-cyclohexanediyl)bis(nitrilomethylidyne)]-bis[4,6-di-tert-butyl)phenol] are initially charged in 50 ml of ethanol and admixed with 2.53 g (0.01 mol) of vanadyl sulfate pentahydrate. After three hours under reflux and complete conversion (TLC monitoring), the solvent is distilled off, the residue taken up in 200 ml of dichloromethane and the solution washed with 100 ml of water. After phase separation, drying of the solution with sodium sulfate and distilling off the solvent, 5.7 g of dark green, amorphous powder (yield: 81% of theory, based on a vanadium:salen ligand of 1:1) are obtained.

Characterization (cf. Y. N. Belokon: Tetrahedron 57, 2001, 777):

| | |
|---|---|
| Color | dark green |
| Melting point | 233° C. |

[α]D²⁰ = −1000 (c = 0.01; CHCl₃)
diamagnetic

| | |
|---|---|
| IR (KBr) | ν = 2950 (s), 2870 (m), 2350 (w), 2320 (w), 1610 (vs), |
| | 1550 (m), 1250 (vs), 1210 (s), 1010 (m) [cm⁻¹]. |

### Comparative Example 1b

Synthesis of the VO-salen complex with the salen ligand (IIa):

5.56 g (0.01 mol) of (R,R)-2,2′-[1,2-cyclohexanediyl)bis(nitrilomethylidyne)]-bis[4,6-di-tert-butyl)phenol] are initially charged in 50 ml of ethanol and admixed with 3.8 g (0.015 mol) of vanadyl sulfate pentahydrate. After three hours under reflux and complete conversion (TLC monitoring), the solvent is distilled off, the residue taken up in 200 ml of dichloromethane and the solution washed with 100 ml of water. After phase separation, drying of the solution with sodium sulfate and distilling off the solvent, 5.0 g of green, amorphous powder are obtained.

### Comparative Examples 1c and d

Synthesis of the VO-salen complex with the salen ligand (IIa)

These catalysts were prepared in a similar manner to Example 1, using a vanadium:salen ligand ratio of

c) 1:2.5

d) 1:2.9

Conversion of Aldehydes (IV) with VO-Salen Complexes

### Example 2

Conversion of 2-chlorobenzaldehyde using VO-salen complex from Example 1:

A flask equipped with stirrer and internal thermometer is initially charged with 150 ml of toluene. 0.09 g (0.08×10⁻³ mol) of (R,R)-VO salen complex from Example 1 and 21.1 g (0.15 mol) of 2-chlorobenzaldehyde (freshly dist.) are added in succession with stirring. 10.1 g (0.375 mol) of hydrocyanic acid are then added all at once. The dark green, homogeneous solution is stirred at room temperature for 24 hours in the closed apparatus. The conversion according to GC is: 98%; 73% ee for the (S)-2-chloromandelic acid cyanohydrin.

Hydrolysis:

150 ml of diisopropyl ether and 112.5 g of concentrated hydrochloric acid (36.5%) are added to the reaction mixture. The mixture is stirred at 60° C. for 6 hours. Two phases form.

Subsequently, 100 ml of water are added to the reaction mixture and the organic phase is removed. The aqueous phase is extracted twice with 100 ml of DIPE (diisopropyl ether) each time. The combined organic phases are concentrated to dryness. The crude product is recrystallized from 150 ml of toluene.

The yield is 15.4 g of (S)-2-chloromandelic acid (55% of theory, based on 2-chlorobenzaldehyde; 96% ee).

### Comparative Example 2a-d

Conversion of 2-chlorobenzaldehyde with the VO-salen complex from Comparative Examples 1a-d:

The cyanohydrin reactions were carried out as described in Example 2, using the complexes prepared in each of the Comparative Examples 1a-d.

The results of the cyanohydrin reactions can be taken from the table.

| | | | Cyanohydrin | |
|---|---|---|---|---|
| | Catalyst | Vanadium/ | Conversion to | ee |
| | from | salen | cyanohydrin in | (cyanohydrin) |
| Example | Example | ligand ratio | [%] | in [%] |
| 2 | 1 | 1:2.2 | 98 | 73 |
| 2a | 1a | 1:1 | 57 | 25 |
| 2b | 1b | 1.5:1.0 | 63 | 27 |
| 2c | 1c | 1:2.5 | 86 | 62 |
| 2d | 1d | 1:2.9 | 94 | 64 |

### Comparative Example 2e

Conversion of 2-chlorobenzaldehyde with salen ligand IIa:

A flask equipped with stirrer and internal thermometer is initially charged with 150 ml of toluene. 0.16 g (0.3×10⁻³ mol) of salen ligand IIa and 21.1 g (0.15 mol) of 2-chlorobenzaldehyde (freshly dist.) are added in succession with stirring. 10.1 g (0.375 mol) of hydrocyanic acid are then added all at once. The yellow, homogeneous solution is stirred at room temperature for 24 hours in the closed apparatus. The conversion according to GC is: 78%; 0% ee.

### Comparative Example 2f

Conversion of 2-chlorobenzaldehyde with the monolithium salt of salen ligand (IIa) (THL 2000, 41, 7457-7460):

A flask equipped with stirrer and internal thermometer is initially charged with 150 ml of toluene. 0.17 g (0.3×10⁻³ mol) of the monolithium salt of salen ligand (IIa) and 21.1 g (0.15 mol) of 2-chlorobenzaldehyde (freshly dist.) are added in succession with stirring. 10.1 g (0.375 mol) of hydrocyanic acid are then added all at once. The yellow, homogeneous solution is stirred at room temperature for 24 hours in the closed apparatus.

The conversion according to GC is: 78%; 1% ee.

### Example 3

Conversion of 2-chlorobenzaldehyde using VO-salen complex from Example 1:

A flask equipped with stirrer and internal thermometer is initially charged with 150 ml of dichloromethane. 0.18 g (0.15×10⁻³ mol) of (R,R)-VO salen complex from Example 1 and 21.1 g (0.15 mol) of 2-chlorobenzaldehyde (freshly dist.) are added in succession with stirring. 10.1 g (0.375 mol) of hydrocyanic acid are then added all at once. The dark green, homogeneous solution is stirred at room temperature for 24 hours in the closed apparatus. The conversion according to GC is: 95%; 80% ee for the (S)-2-chloromandelic acid cyanohydrin.

### Example 4

Conversion of 2-chlorobenzaldehyde using VO-salen complex from Example 1:

A flask equipped with stirrer and internal thermometer is initially charged with 150 ml of diisopropyl ether. 0.09 g (0.08×10⁻³ mol) of (R,R)-VO salen complex from Example 1 and 21.1 g (0.15 mol) of 2-chlorobenzaldehyde (freshly dist.) are added in succession with stirring. 10.1 g (0.375 mol) of hydrocyanic acid are then added all at once. The dark green, homogeneous solution is stirred at room temperature for 24 hours in the closed apparatus. The conversion according to GC is: 99%; 70% ee for the (S)-2-chloromandelic acid cyanohydrin.

### Example 5

Synthesis of VO-salen complex with the salen ligand (IIb):

(IIb), R,R-enantiomer, R=tert-butyl, R′=methyl

4.63 g (0.01 mol) of (R,R)-2,2′-[1,2-cyclohexanediyl)bis(nitrilomethylidyne)]-bis[4-methyl-6-tert-butyl)phenol] are initially charged in 50 ml of ethanol and admixed with 1.14 g (0.0045 mol) of vanadyl sulfate pentahydrate. After three hours under reflux and complete conversion (TLC monitoring), the solvent is distilled off, the residue taken up in 200 ml of dichloromethane and the solution washed with 100 ml of water. After phase separation, drying of the solution with sodium sulfate and distilling off the solvent, 5.3 g of green, amorphous powder are obtained.

### Example 6

Conversion of 2-chlorobenzaldehyde with VO-salen complex from Example 5:

A flask equipped with stirrer and internal thermometer is initially charged with 75 ml of toluene. 0.09 g (0.09×10⁻³ mol) of (R,R)-VO salen complex from Example 5 and 21.1 g (0.15 mol) of 2-chlorobenzaldehyde (freshly dist.) are added in succession with stirring. 10.1 g (0.375 mol) of hydrocyanic acid are then added all at once. The dark green, homogeneous solution is stirred at room temperature for 24 hours in the closed apparatus. The conversion according to GC is: 99%; 65% ee for the (S)-2-chloromandelic acid cyanohydrin.

### Example 7

Synthesis of the VO-salen complex with the salen ligand (IIc):

(IIc), R,R-enantiomer, R=tert-butyl, R′=methoxy

4.95 g (0.01 mol) of (R,R)-2,2′-[1,2-cyclohexanediyl)bis(nitrilomethylidyne)]-bis[4-methyoxy-6-tert-butyl)phenol] are initially charged in 50 ml of ethanol and admixed with 1.14 g (0.0045 mol) of vanadyl sulfate pentahydrate. After three hours under reflux and complete conversion (TLC monitoring), the solvent is distilled off, the residue taken up in 200 ml of dichloromethane and the solution washed with 100 ml of water. After phase separation, drying of the solution with sodium sulfate and distilling off the solvent, 6.0 g of green, amorphous powder are obtained.

### Example 8

Conversion of 2-chlorobenzaldehyde using VO-salen complex from Example 7:

A flask equipped with stirrer and internal thermometer is initially charged with 75 ml of toluene. 0.09 g (0.09×10⁻³ mol) of (R,R)-VO salen complex from Example 7 and 21.1 g (0.15 mol) of 2-chlorobenzaldehyde (freshly dist.) are added in succession with stirring. 10.1 g (0.375 mol) of hydrocyanic acid are then added all at once. The dark green, homogeneous solution is stirred at room temperature for 24 hours in the closed apparatus. The conversion according to GC is: 91%; 54% ee for the (S)-2-chloromandelic acid cyanohydrin.

1. An optically active catalyst containing a salen ligand of the formula (II) and vanadium in the oxidation state (IV) 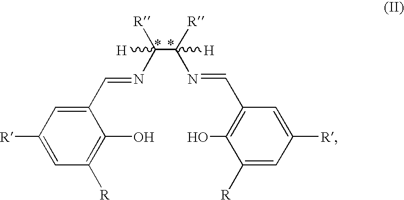
where the R, R′ and R″ radicals of the salen ligand are each independently hydrogen, branched or unbranched C₁-C₁₀ alkyl radicals, an O(C₁-C₄-alkyl) group, F, Cl, Br, I, or an optionally substituted aryl group or —(CH₂)ₘ— where m is an integer in the range from 1 to 8, and the catalyst contains from 1.4 to 10 equivalents of salen ligand based on one equivalent of vanadium (IV).

2. An optically active catalyst as claimed in claim 1, wherein the catalyst contains from 1.4 to 5 equivalents of the salen ligand of the formula (II), based on one equivalent of vanadium (IV).

3. An optically active catalyst as claimed in claim 1, wherein the catalyst contains from 1.4 to 3 equivalents of a salen ligand of the formula (II), based on one equivalent of vanadium (IV).

4. A process for preparing an optically active catalyst as claimed in claim 1 comprising the step of reacting a vanadyl(IV) salt with from 1.4 to 10 equivalents of the salen ligand in a solvent at a temperature in the range from 0 to 120° C.

5. The process as claimed in claim 4, wherein the solvent used is an aliphatic or aromatic alcohol, or a mixture of aliphatic halogenated or aromatic alcohols with hydrocarbons.

6. The process as claimed in claim 4, wherein the salen ligand (II) is used in a concentration of from 0.005 to 5 mol/l, based on the solvent.

7. The process as claimed in claim 4, wherein the reaction time is from 1 to 24 h.

8. A catalyst obtained by the process as claimed in claim 4.

9. A method for preparing optically active cyanohydrins comprising the step of mixing the optically active catalyst as claimed in claim 1, with an aldehyde a CN source and a solvent.

10. The method as claimed in claim 9, wherein the optically active cyanohydrins of the formula (III) are prepared 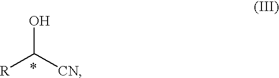
where the optically active center * has the absolute configuration (R) or (S), R is an optionally branched alkyl, alkenyl or alkynyl radical of chain length C₁ to C₂₀ or is a radical of the formula (IIIa) 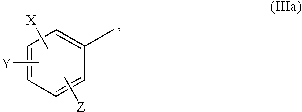
where X, Y and Z are each independently the same or different and are H, F, Cl, Br, I, OH, NH₂, O(C₁-C₄-alkyl), OCOCH₃, NHCOCH₃, NO₂ or C₁-C₄-alkyl.

11. The method of claim 9, wherein the CN source is HCN.

12. An optically active cyanohydrin made in accordance with the method of claim 9.
